(19) United States
(12) Patent Application Publication
(10) Pub. No.: US 2026/0300669 A1
(43) Pub. Date: Oct. 1, 2026

(54) CARD RING HAVING NON-CONTACT SHORT-DISTANCE WIRELESS COMMUNICATION FUNCTION AND METHOD FOR MANUFACTURING SAME

(71) Applicant: Jiyong JUNG, Seoul (KR)

(72) Inventor: Jiyong JUNG, Seoul (KR)

(21) Appl. No.: 19/100,994

(22) PCT Filed: Jul. 11, 2023
(86) PCT No.: PCT/KR2023/009834

§ 371 Date: Feb. 4, 2025

(30) Foreign Application Priority Data
Aug. 8, 2022 (KR) 10-2022-0098737

(51) Int. Cl. A44C 9/00; G06K 19/07; G06K 19/077

(52) U.S. Cl. CPC A44C 9/0053; G06K 19/0723; G06K 19/0772; G06K 19/07779

(57) ABSTRACT

A card ring includes: an integrated circuit element (IC chip) for control and a booster circuit module; a loop antenna; and a body portion having a ring shape and on which the integrated circuit element for control and the loop antenna are mounted. The body portion includes a slit formed by completely cutting a region of the body portion, an antenna groove, and an integrated circuit element groove, wherein the loop antenna is mounted in a state of being wound several times along the antenna groove, the integrated circuit element for control is mounted in the integrated circuit element groove, and the exposed slit, the antenna groove, and the integrated circuit element groove of the body portion are filled with curable epoxy. The booster circuit module includes a circuit having a certain capacitance.

### TECHNICAL FIELD

The present invention relates to a card ring having a non-contact short-distance wireless communication function and a method of manufacturing the same, and more specifically, to a card ring configured to have a non-contact short-distance wireless communication function by configuring a single body unit, mounting a control integrated circuit element (IC chip), a booster circuit module, and a loop antenna that allows non-contact short-distance wireless communication on the body unit, and then filling an exposed area of the body unit with a curable epoxy, and a method of manufacturing of the card ring.

### BACKGROUND ART

Recently, use of credit cards is increasing, and transportation cards, debit cards, and the like are used for small payments. According to use types of these cards, various methods are proposed to minimize the risk of losing the cards while making the cards easy to use.

As examples of such a method, ring-shaped cards are proposed. Korean Utility Model Registration No. 20-0294180 relates to “Ring with an IC chip” and discloses a ring with an IC chip embedded in an accessory such as a ring, a watch, or the like to perform many functions of credit cards, transportation cards, electronic money, parking lot access cards, department store cards, and the like through an IC card. The ring with an embedded IC chip according to the design described above is configured in a structure in which a loop antenna connected to the IC chip and providing a non-contact short-distance wireless communication function wraps around the body of the ring. The loop antenna connected to the IC chip performs non-contact short-distance wireless communication with an external terminal, and through the non-contact short-distance wireless communication, the loop antenna generates and provides an induced current to the IC chip, and also transmits and receives data to and from the external terminal.

However, when the loop antenna wraps around the metal material, the loop antenna may not generate the induced current as a metal material has a characteristic of attenuating intensity of a signal received from an external terminal, and it is also difficult to transmit and receive data to and from an external terminal.

Therefore, in order to smoothly perform the non-contact short-distance wireless communication function of the IC chip, the body of the ring should be configured of an electrically insulating material through which electricity does not flow. Therefore, the ring according to the design described above has a limitation in that it may not be manufactured using a metal material or a precious metal material through which electricity flows, and should be manufactured using an electrically insulating material, such as a synthetic resin such as plastic, ceramics, or the like, through which electricity does not flow.

To solve these problems, inventors of the present patent have proposed Korean Patent Registration No. 10-2070245. The registered patent relates to “Metal accessory having non-contact short-range wireless communication function, and manufacturing method therefor”, in which the body unit of the metal accessory is divided into a first body unit and a second body unit that can be combined with each other, and a control integrated circuit element and a loop antenna are mounted between the body units. FIG. 1 is an exploded perspective view showing the structure of a metal accessory according to a conventional technique. However, although the two body units of the metal accessory according to the patent described above should precisely form a groove along the inner circumferential surface as shown in FIG. 1, this process is not easy. In addition, as the metal accessory according to the patent described above should be manufactured by dividing the accessory into two body units, mounting an antenna module and an integrated circuit element between the body units, and combining the two body units to each other, the manufacturing process is complicated, and the combining process is not easy. Therefore, there is a problem in that mass production is difficult, and manufacturing costs increase.

### SUMMARY OF THE INVENTION

Therefore, the present invention has been made in view of the above problems, and it is an object of the present invention to provide a card ring that is easy to manufacture as it is configured of a single body unit and may smoothly provide a non-contact short-distance wireless communication function, and a manufacturing method thereof.

### TECHNICAL SOLUTION

A method of manufacturing a card ring according to a first feature of the present invention for accomplishing the object described above comprises: a control integrated circuit element (IC chip) capable of performing non-contact short-distance wireless communication with an external card reader; a loop antenna configured of a film-coated coil having a predetermined length, both ends of the coil being connected to both ends of the control integrated circuit element, respectively; and a body unit made of a metal or precious metal material, configured in a ring shape having a through hole formed at a center, and provided with the control integrated circuit element and the loop antenna mounted therein.

The body unit includes: a slit formed by completely cutting an area of the body unit; an antenna groove formed along an outer circumferential surface of the body unit; and an integrated circuit element groove formed in a predetermined area of the body unit, wherein the loop antenna is mounted in a state of being wound several times along the antenna groove, the control integrated circuit element is mounted in the integrated circuit element groove, and the exposed slit, antenna groove, and integrated circuit element groove of the body unit are filled with an insulating filling material.

A method of manufacturing a card ring according to a second feature of the present invention comprises: a control integrated circuit element (IC chip) capable of performing non-contact short-distance wireless communication with an external card reader; a loop antenna configured of a film-coated coil having a predetermined length, both ends of the coil being connected to both ends of the control integrated circuit element, respectively; and a body unit configured in a ring shape having a through hole formed at a center, and provided with the control integrated circuit element and the loop antenna mounted therein.

The body unit includes: an antenna groove formed along an outer circumferential surface of the body unit; and an integrated circuit element groove formed in a predetermined area of the body unit, wherein the loop antenna is mounted in a state of being wound several times along the antenna groove, the control integrated circuit element is mounted in the integrated circuit element groove, and the exposed antenna groove and integrated circuit element groove of the body unit are filled with an insulating filling material.

In the card ring according to the first and second features described above, it is preferable that the filling material is made of a cured curable epoxy or a mixed material of the cured curable epoxy and a pigment.

It is preferable that the card ring according to the first and second features described above is configured to further comprise a booster circuit module configured as a circuit having a predetermined capacitance and connected to the control integrated circuit element in parallel, and the booster circuit module is configured to make an operating frequency the highest matching frequency by adjusting a capacitance of the control integrated circuit element, and it is further preferable that the capacitance of the booster circuit module is determined according to the shape and size of the body unit of the card ring.

A method of manufacturing a card ring according to a third feature of the present invention comprises the steps of: (a) manufacturing a structure of a metal material having a ring shape; (b) forming an antenna groove by etching the structure along an outer circumferential surface of the structure at a predetermined width and depth, and forming an integrated circuit element groove by etching a predetermined area of the structure at a predetermined size and depth; (c) forming a slit by completely cutting an area of the structure; (d) mounting a loop antenna in the antenna groove of the structure by winding several times; (e) connecting both ends of the loop antenna to a control integrated circuit element (IC chip) capable of performing non-contact short-distance wireless communication with an external card reader, coating the control integrated circuit element with an insulating material, and then mounting the control integrated circuit element in the integrated circuit element groove of the structure; and (f) filling a filling material containing a curable epoxy into the antenna groove, the integrated circuit device groove, and the slit of the structure, and then curing the filling material.

A method of manufacturing a card ring according to a fourth feature of the present invention comprises the steps of: (a) manufacturing a structure of a metal material having a ring shape; (b) forming an antenna groove by etching the structure along an outer circumferential surface of the structure at a predetermined width and depth, and forming an integrated circuit element groove by etching a predetermined area of the structure at a predetermined size and depth; (c) mounting a loop antenna in the antenna groove of the structure by winding several times; (d) connecting both ends of the loop antenna to a control integrated circuit element (IC chip) capable of performing non-contact short-distance wireless communication with an external card reader, coating the control integrated circuit element with an insulating material, and then mounting the control integrated circuit element in the integrated circuit element groove of the structure; and (e) filling a filling material containing a curable epoxy into the antenna groove and the integrated circuit device groove of the structure, and then curing the filling material.

It is preferable that the method of manufacturing a card ring according to the third and fourth features described above further comprises the step of (g) plating or coating the surface after polishing the epoxy exposed on the surface of the structure.

In the method of manufacturing a card ring according to the third and fourth features described above, it is preferable to remove bubbles in the curable epoxy using a high temperature or high pressure before filling the filling material containing a curable epoxy, and fill the curable epoxy from which the bubbles are removed into the structure.

It is preferable that the method of manufacturing a card ring according to the third and fourth features described above further comprises the step of manufacturing a booster circuit module configured to have a predetermined capacitance, and connecting the booster circuit module to the control integrated circuit device in parallel, and it is further preferable that the capacitance of the booster circuit module is determined according to the shape and size of the structure that will be the body unit of the card ring that determines the diameter and length of the loop antenna.

### ADVANTAGEOUS EFFECTS

As a card ring according to the present invention having the configuration as described above is manufactured in a ring shape and has a control integrated circuit element and a loop antenna mounted therein to allow non-contact wireless communication, functions of non-contact credit cards, transportation cards, and the like can be provided.

In addition, as a card ring according to the present invention is manufactured using a metal material or a precious metal material of a ring shape having a through hole formed at the center and is provided with a slit cut in a predetermined area of the ring-shaped body, the card ring may provide functions of non-contact credit cards, transportation cards, and the like, while the appearance is the same as a conventional precious metal ring.

In addition, as a card ring according to the present invention is configured of a single-structure body unit, and a filling material containing a curable epoxy is filled and cured in a groove exposed to mount an antenna and an integrated circuit element, and the surface is polished, it is easy to manufacture.

In addition, as a card ring according to the present invention is configured to operate at the highest matching frequency by connecting a booster circuit module to adjust capacitance of the integrated circuit element, the recognition distance of the card ring can be maximized.

### BRIEF DESCRIPTION OF THE DRAWINGS

FIG. 1 is an exploded perspective view showing the structure of a metal accessory according to a conventional technique.

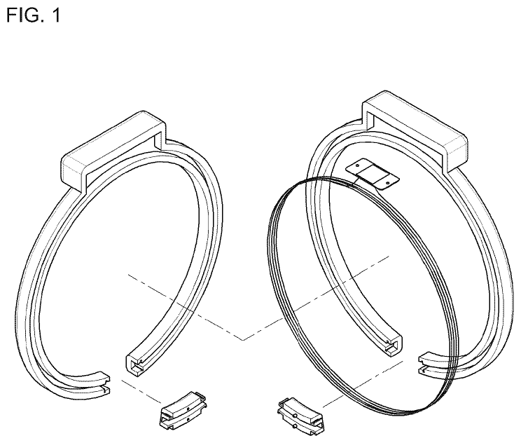

FIG. 2 is a front perspective view and a back perspective view showing a card ring having a non-contact short-distance wireless communication function according to a preferred embodiment of the present invention.

FIG. 3 is a mimetic view showing a state of electrically connecting a loop antenna, a control integrated circuit element, and a booster circuit module in a card ring having a non-contact short-distance wireless communication function according to a preferred embodiment of the present invention.

FIG. 4 is an exemplary view showing various shapes of slits formed in a body unit of a card ring according to a preferred embodiment of the present invention.

FIG. 5 is a flowchart sequentially illustrating a method of manufacturing a card ring having a non-contact short-distance wireless communication function according to a preferred embodiment of the present invention.

FIG. 6 is a perspective view exemplarily showing a structure in which an antenna groove, an integrated circuit element groove, and a slit are formed, i.e., a structure that will be the body unit of a ring, in a method of manufacturing a card ring according to a preferred embodiment of the present invention.

FIG. 7 is a perspective view exemplarily showing a state of mounting a loop antenna, a control integrated circuit element, and a booster circuit module in a structure that will be the body unit of the ring in a method of manufacturing a card ring according to a preferred embodiment of the present invention.

### DETAILED DESCRIPTION OF THE INVENTION

As a card ring having a non-contact short-distance wireless communication function according to the present invention is configured to perform non-contact short-distance wireless communication with an external terminal as an integrated circuit element and a loop antenna are mounted in a body unit configured in a single shape, it can be conveniently used as a credit card or the like.

Hereinafter, the structure, operation and manufacturing method of a card ring having a non-contact short-distance wireless communication function according to preferred embodiments of the present invention will be described in detail with reference to the accompanying drawings.

### Card Ring

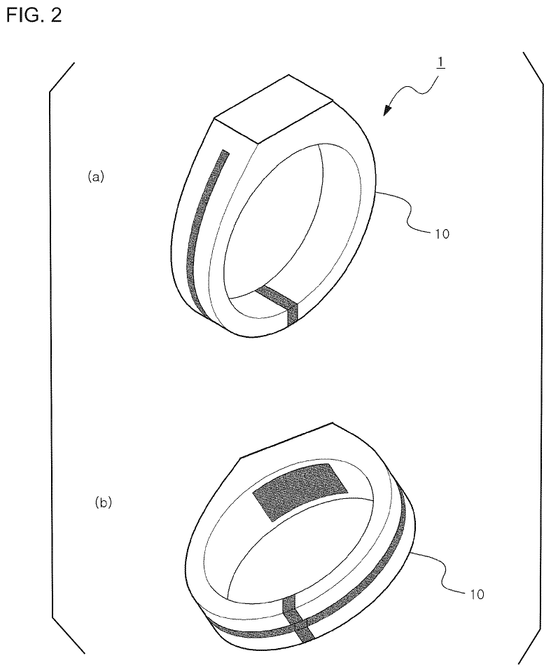

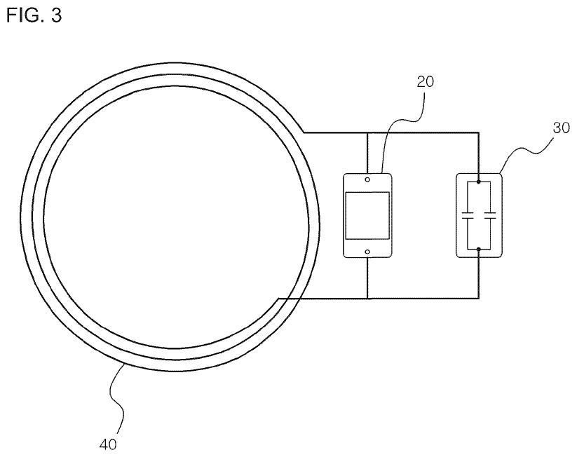

FIG. 2 is a front perspective view and a back perspective view showing a card ring having a non-contact short-distance wireless communication function according to a preferred embodiment of the present invention. Referring to FIG. 2 and FIG. 3 described below, a card ring 1 according to the present invention includes a body unit 10, a control integrated circuit element 20, a booster circuit module 30, and a loop antenna 40.

The control integrated circuit element 20 is an integrated circuit element (IC chip) capable of performing non-contact short-distance wireless communication with an external terminal, and performs non-contact short-distance wireless communication with an external card reader through the loop antenna to receive an induced current generated by an induced electromotive force, and transmit and receive data, and a preset program may be driven using the transmitted and received data. The control integrated circuit element described above may be configured as an IC chip for a credit card, an IC chip for payment, or an IC chip for a door lock, which are driven in a non-contact manner. When the control integrated circuit element is an IC chip for a card, the card ring according to the present invention may perform the function of a credit card, a transportation card, a payment card, or the like. In addition, when the control integrated circuit element is an IC chip for a door lock, the card ring according to the present invention may perform the function of a portable key for a door lock.

The card ring according to the present invention should be manufactured in various sizes according to the ring size, and the length of the coil configuring the loop antenna and the diameter of the antenna change according to the size of the ring. In addition, according to the design of the card ring, there will be a structural difference in the body unit of the ring, i.e., a difference in the size of the head unit of the ring, the width or thickness of the body, and the like, and due to this, the length of the coil configuring the loop antenna and the diameter of the antenna change according to the design of the card ring, which will result in the structural difference. According thereto, there is a problem in that according to the length and diameter of the loop antenna that will change according to the size or design of each card ring, the internal capacitance C of the integrated circuit element mounted in the ring changes, and the operating frequency of the integrated circuit element determined by “operating frequency (F)=1/(2πRC)” Changes.

To solve this problem, in the card ring according to the present invention, a booster circuit module is connected to the integrated circuit element. The booster circuit module 30 is configured as a circuit that provides a predetermined capacitance and is connected to both ends of the control integrated circuit element in parallel. The circuit that provides a predetermined capacitance may be configured of capacitors or other semiconductor devices. In the present invention, a module configured by connecting one or two or more capacitors in series or in parallel is exemplified as the booster circuit module.

The capacitance of the booster circuit module may be determined according to the size and design of the body unit that determines the length and diameter of the loop antenna.

It is desirable to maintain the operating frequency of the integrated circuit element at the matching frequency of the integrated circuit element by adjusting the capacitance of the integrated circuit element to control the operating frequency by connecting the booster circuit module to the control integrated circuit element in parallel. As the operating frequency of the integrated circuit element is maintained at the matching frequency in this way, the recognition distance of the card ring can be maximized.

It is preferable that the integrated circuit element and the booster circuit module are electrically insulated by wrapping the surfaces with a shrink tube, a high-temperature tape, or the like or coating the surfaces with an electrically insulating material. As the surfaces of the integrated circuit element and the booster circuit module are electrically insulated in this way, they are prevented from being in contact with the body unit of a metal material and generating a short circuit.

The loop antenna 40 is an antenna configured by connecting a coil of a predetermined length to both ends of the control integrated circuit element and the booster circuit module applied with an insulating material on the surface and connected to each other in parallel, and the loop antenna is mounted inside the body unit together with the control integrated circuit element and the booster circuit module. The loop antenna 40 is preferably configured to be wound several times along the outer circumferential surface of the ring-shaped body unit. In order to obtain a signal strength required for smooth data transmission and reception with an external terminal, the loop antenna is preferably configured to have a total length of about 700 mm or more.

FIG. 3 is a mimetic view showing a state of electrically connecting a loop antenna, a control integrated circuit element, and a booster circuit module in a card ring having a non-contact short-distance wireless communication function according to a preferred embodiment of the present invention. Referring to FIG. 3, both ends of the loop antenna 40 wound several times along the outer circumferential surface of the body unit of the card ring are connected to both ends of the control integrated circuit element 20 and the booster circuit module 30 in parallel.

The body unit 10 is formed in a ring shape having a through hole formed at the center, and is configured to mount the control integrated circuit element, the booster circuit module, and the loop antenna. The body unit 10 includes an antenna groove 100 formed along the outer circumferential surface of the body unit, and an integrated circuit element groove 110 formed in a predetermined area of the body unit. The coil configuring the loop antenna is mounted to be wound several times along the antenna groove, and the control integrated circuit element and the booster circuit module connected in parallel with each other are mounted in the integrated circuit element groove.

Meanwhile, the body unit 10 may be manufactured using various materials, such as a non-metal material, a metal material, a precious metal material, or the like generally used for a ring. However, when the body unit is made of a metal material having electrical conductivity, the loop antenna may not transmit and receive signals of an external card reader due to the body unit of a metal material, so that the integrated circuit element that should operate in a non-contact manner may not operate normally. In order to solve this problem, the body unit should further include a slit 120 formed by completely cutting an area. As a slit is provided in the body unit of the card ring, when the ring approaches an external card reader, an induced current is generated in the loop antenna by an electromotive force induced by the card reader, and the induced current generated in the antenna is supplied to the non-contact integrated circuit element, so that the integrated circuit element operates normally.

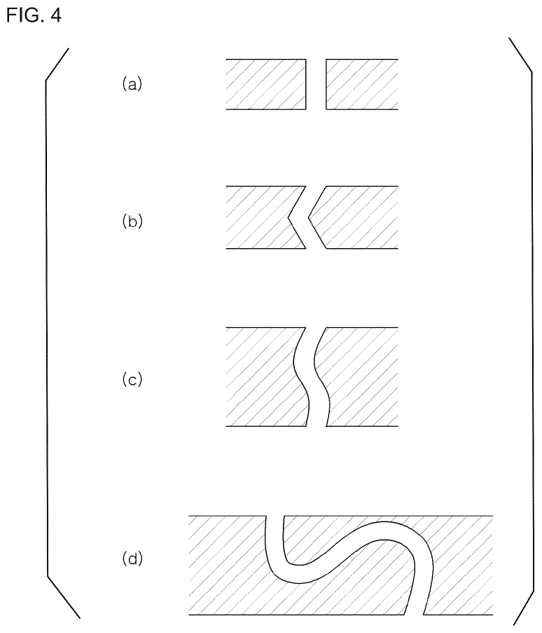

FIG. 4 is an exemplary view showing various shapes of slits formed in a body unit of a card ring according to a preferred embodiment of the present invention. Referring to FIG. 4, the slit is made by cutting an area of the ring-shaped body unit, and its shape may be variously configured as a curve, a straight line, a diagonal line, a figure, or the like, and may also be configured in a predetermined pattern.

The slit of the body unit and the exposed areas of the antenna groove having the loop antenna mounted therein and the integrated circuit groove having the integrated circuit element and the booster circuit module are filled with an electrically insulating resin material. The filling material is preferably made of a curable epoxy or a mixed material of a curable epoxy and a pigment. In particular, as the material prepared by mixing a curable epoxy and a predetermined pigment is filled and cured in the slit and the exposed areas of the antenna groove and the integrated circuit element groove, and the surface of the body unit where the cured filling material is exposed is polished, the cured filling material functions as a pattern having a specific color.

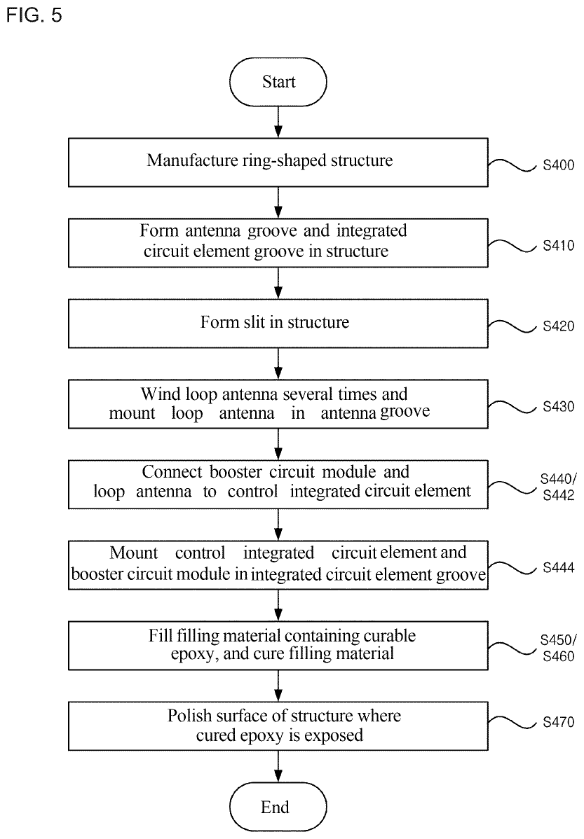

Hereinafter, a method of manufacturing a card ring according to the present invention will be described in detail with reference to FIG. 5. FIG. 5 is a flowchart sequentially illustrating a method of manufacturing a card ring having a non-contact short-distance wireless communication function according to a preferred embodiment of the present invention.

Referring to FIG. 5, a method of manufacturing a card ring according to the present invention first manufactures a ring-shaped structure that will be the body unit of the card ring (step 400).

Next, an antenna groove is formed by etching the ring-shaped structure along the outer circumferential surface of the ring-shaped structure at a predetermined width and depth, and an integrated circuit element groove is formed by etching an arbitrary area of the structure at a predetermined depth (step 410). Both ends of the antenna groove should be etched to be connected to the integrated circuit element groove. It is preferable that the integrated circuit element groove is formed on the back side of the head unit of the ring.

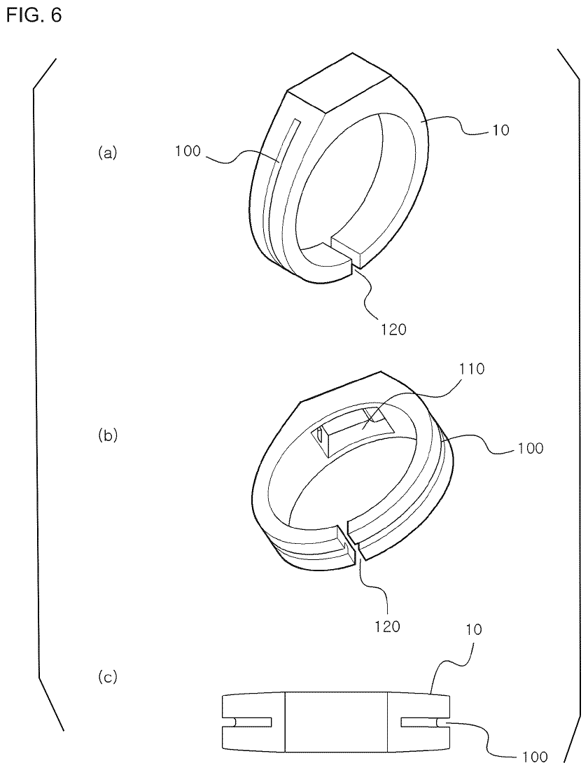

Next, when the ring-shaped structure is a metal structure, the slit is formed by cutting an area of the ring shape (step 420). FIG. 6 is a front perspective view, a back perspective view, and a front view exemplarily showing a structure 10 in which the antenna groove 100, the integrated circuit element groove 110, and the slit 120 are formed, i.e., a structure that will be the body unit of a ring, in a method of manufacturing a card ring according to a preferred embodiment of the present invention.

Next, a loop antenna is wound several times and mounted in the antenna groove of the structure (step 430).

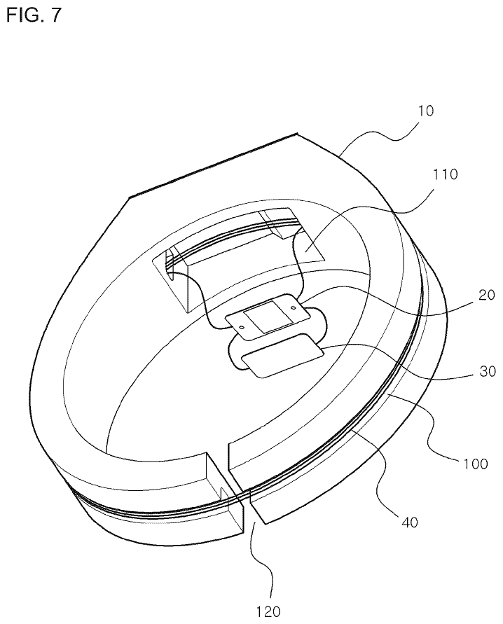

Next, after connecting the booster circuit module to both ends of the control integrated circuit element in parallel (step 440) and connecting both ends of the loop antenna to the both ends of the control integrated circuit element (step 442), an insulating material is applied to the surfaces of the control integrated circuit element and the booster circuit module, and the control integrated circuit element and the booster circuit module are mounted in the integrated circuit element groove of the structure (step 444). FIG. 7 is a perspective view exemplarily showing a state of mounting a loop antenna, a control integrated circuit element, and a booster circuit module in a structure that will be the body unit of the ring in a method of manufacturing a card ring according to a preferred embodiment of the present invention.

Next, a filling material containing a curable epoxy is prepared by applying a high temperature or high pressure to remove bubbles in the epoxy (step 450). Next, the filling material, from which the bubbles are removed, is filled into the exposed antenna groove and integrated circuit element groove of the structure and the slit formed by cutting an area of the structure, and cured by exposing to a UV lamp (step 460). The filling material may be configured of only a curable epoxy or may be configured of a mixed material of the curable epoxy and a pigment. In this way, as the curable epoxy, from which the bubbles are removed, is filled in the antenna groove, the integrated circuit element groove, and the slit of the metal structure, the structure of the cured epoxy is formed densely, and solidity and aesthetics as a ring can be increased.

Next, after polishing the surface of the structure where the epoxy is cured, the surface is plated or coated (step 470).

Through the process described above, manufacturing a card ring capable of non-contact wireless communication as shown in FIG. 2 is completed.

Although the present invention has been described focusing on preferred embodiments thereof, these are merely examples and do not limit the present invention, and those skilled in the art will understand that various modifications and applications not exemplified above are possible without departing from the essential characteristics of the present invention. In addition, differences related to such modifications and applications should be interpreted as being included in the scope of the present invention defined in the appended claims.

1. A card ring having a non-contact short-distance wireless communication function, the ring comprising:
a control integrated circuit element (IC chip) capable of performing non-contact short-distance wireless communication with an external card reader;
a loop antenna configured of a film-coated coil having a predetermined length, both ends of the coil being connected to both ends of the control integrated circuit element, respectively; and
a body unit made of a metal or precious metal material, configured in a ring shape having a through hole formed at a center, and provided with the control integrated circuit element and the loop antenna mounted therein, wherein
the body unit includes:
a slit formed by completely cutting an area of the body unit;
an antenna groove formed along an outer circumferential surface of the body unit; and
an integrated circuit element groove formed in a predetermined area of the body unit, wherein
the loop antenna is mounted in a state of being wound several times along the antenna groove, the control integrated circuit element is mounted in the integrated circuit element groove, and the exposed slit, antenna groove, and integrated circuit element groove of the body unit are filled with an insulating filling material.

2. The card ring according to claim 1, wherein the filling material is a cured curable epoxy.

3. The card ring according to claim 1, wherein the filling material is a mixed material of a cured curable epoxy and a pigment.

4. The card ring according to claim 1, further comprising a booster circuit module configured as a circuit having a predetermined capacitance and connected to the control integrated circuit element in parallel, wherein the booster circuit module is configured to make an operating frequency the highest matching frequency by adjusting a capacitance of the control integrated circuit element.

5. The card ring according to claim 4, wherein the capacitance of the booster circuit module is determined according to a shape and a size of the body unit of the card ring.

6. A card ring having a non-contact short-distance wireless communication function, the ring comprising:
a control integrated circuit element (IC chip) capable of performing non-contact short-distance wireless communication with an external card reader;
a loop antenna configured of a film-coated coil having a predetermined length, both ends of the coil being connected to both ends of the control integrated circuit element, respectively; and
a body unit configured in a ring shape having a through hole formed at a center, and provided with the control integrated circuit element and the loop antenna mounted therein, wherein
the body unit includes:
an antenna groove formed along an outer circumferential surface of the body unit; and
an integrated circuit element groove formed in a predetermined area of the body unit, wherein
the loop antenna is mounted in a state of being wound several times along the antenna groove, the control integrated circuit element is mounted in the integrated circuit element groove, and the exposed antenna groove and integrated circuit element groove of the body unit are filled with an insulating filling material.

7. The card ring according to claim 6, wherein the filling material is a cured curable epoxy.

8. The card ring according to claim 6, wherein the filling material is a mixed material of a cured curable epoxy and a pigment.

9. The card ring according to claim 6, further comprising a booster circuit module configured as a circuit having a predetermined capacitance and connected to the control integrated circuit element in parallel, wherein the booster circuit module is configured to make an operating frequency the highest matching frequency by adjusting a capacitance of the control integrated circuit element.

10. The card ring according to claim 9, wherein the capacitance of the booster circuit module is determined according to a shape and a size of the body unit of the card ring.

11. A method of manufacturing a card ring having a non-contact short-distance wireless communication function, the method comprising the steps of:
(a) manufacturing a structure of a metal material having a ring shape;
(b) forming an antenna groove by etching the structure along an outer circumferential surface of the structure at a predetermined width and depth, and forming an integrated circuit element groove by etching a predetermined area of the structure at a predetermined size and depth;
(c) forming a slit by completely cutting an area of the structure;
(d) mounting a loop antenna in the antenna groove of the structure by winding several times;
(e) connecting both ends of the loop antenna to a control integrated circuit element (IC chip) capable of performing non-contact short-distance wireless communication with an external card reader, coating the control integrated circuit element with an insulating material, and then mounting the control integrated circuit element in the integrated circuit element groove of the structure; and
(f) filling a filling material containing a curable epoxy into the antenna groove, the integrated circuit device groove, and the slit of the structure, and then curing the filling material.

12. The method according to claim 11, further comprising the step of (g) plating or coating, after polishing a surface where the epoxy is cured, the surface of the structure.

13. The method according to claim 11, wherein bubbles in the curable epoxy are removed by applying a high temperature or high pressure before filling the filling material containing a curable epoxy, and the curable epoxy from which the bubbles are removed is filled into the structure.

14. The method according to claim 11, further comprising the step of manufacturing a booster circuit module configured to have a predetermined capacitance, and connecting the booster circuit module to the control integrated circuit device in parallel.

15. The method according to claim 14, wherein the capacitance of the booster circuit module is determined according to a shape and a size of a structure that will be a body unit of the card ring.

16. A method of manufacturing a card ring having a non-contact short-distance wireless communication function, the method comprising the steps of:
(a) manufacturing a structure of a metal material having a ring shape;
(b) forming an antenna groove by etching the structure along an outer circumferential surface of the structure at a predetermined width and depth, and forming an integrated circuit element groove by etching a predetermined area of the structure at a predetermined size and depth;
(c) mounting a loop antenna in the antenna groove of the structure by winding several times;
(d) connecting both ends of the loop antenna to a control integrated circuit element (IC chip) capable of performing non-contact short-distance wireless communication with an external card reader, coating the control integrated circuit element with an insulating material, and then mounting the control integrated circuit element in the integrated circuit element groove of the structure; and
(e) filling a filling material containing a curable epoxy into the antenna groove and the integrated circuit device groove of the structure, and then curing the filling material.

17. The method according to claim 16, further comprising the step of (g) plating or coating, after polishing a surface where the epoxy is cured, the surface of the structure.

18. The method according to claim 16, wherein bubbles in the curable epoxy are removed by applying a high temperature or high pressure before filling the filling material containing a curable epoxy, and the curable epoxy from which the bubbles are removed is filled into the structure.

19. The method according to claim 16, further comprising the step of manufacturing a booster circuit module configured to have a predetermined capacitance, and connecting the booster circuit module to the control integrated circuit device in parallel.

20. The method according to claim 19, wherein the capacitance of the booster circuit module is determined according to a shape and a size of a structure that will be a body unit of the card ring.
